(19) United States
(12) Patent Application Publication
(10) Pub. No.: US 2025/0105887 A1
(43) Pub. Date: Mar. 27, 2025

(54) CODEBOOK SUPPORT FOR DIFFERENT ANTENNA STRUCTURES AND ENHANCED OPERATION FOR FULL POWER MODE 2

(71) Applicant: Intel Corporation, Santa Clara, CA (US)

(72) Inventors: Guotong Wang, Santa Clara, CA (US); Bishwarup Mondal, San Ramon, CA (US); Dong Han, Santa Clara, CA (US); Avik Sengupta, Santa Clara, CA (US)

(21) Appl. No.: 18/834,151

(22) PCT Filed: Apr. 24, 2023
(86) PCT No.: PCT/US2023/066120

§ 371 Date: Jul. 29, 2024

Related U.S. Application Data
(60) Provisional application No. 63/336,152, filed on Apr. 28, 2022.

(30) Foreign Application Priority Data
Apr. 25, 2022 (WO) PCT/CN2022/088883
Apr. 29, 2022 (WO) PCT/CN2022/090168

(51) Int. Cl. H04B 7/0456

(52) U.S. Cl. CPC H04B 7/0456

(57) ABSTRACT

Systems, apparatuses, methods, and computer-readable media are directed to techniques for codebook support for different antenna structures, such as a user equipment (UE) with a non-uniform antenna array (e.g. with different distances between antenna elements) and/or multiple antenna panels. Embodiments further provide techniques for enhanced operation in full power mode 2. For example, embodiments provide techniques for antenna virtualization to form virtual antenna ports from subsets of transmit antennas of the UE (e.g., from eight transmit antennas to two, four, or six virtual antenna ports). Other embodiments may be described and claimed.

### CROSS REFERENCE TO RELATED APPLICATION

The present application claims priority to International Patent Application No. PCT/CN2022/088883, which was filed Apr. 25, 2022; U.S. Provisional Patent Application No. 63/336,152, which was filed Apr. 28, 2022; and International Patent Application No. PCT/CN2022/090168, which was filed Apr. 29, 2022.

### FIELD

Various embodiments generally may relate to the field of wireless communications. For example, some embodiments may relate to codebook support for different antenna structures and/or enhanced operation for full power mode 2.

### BACKGROUND

In Third Generation Partnership Project (3GPP) New Radio (NR) Release (Rel)-15/Rel-16/Rel-17 specification, for uplink transmissions, up to 4 layers can be supported for physical uplink shared channel (PUSCH). The precoders (transmission precoding matrix indicators (TPMIs)) for uplink PUSCH transmission are defined in 3GPP Technical Specification (TS) 38.211, v. 17.1.0, 2022 Apr. 1-depending on the rank value (number of layers), number of antenna ports, and waveform (cyclic prefix (CP)-orthogonal frequency division multiplexing (OFDM) or discrete Fourier transform (DFT)-spread(s)-OFDM). The current codebook is designed for a uniform antenna array, e.g., where the distance among antenna elements is the same.

Furthermore, 3GPP Rel-16 specifications, full power operation is supported including full power Mode 0, full power Mode 1, and full power Mode 2. However, the power modes do not account for user equipments (UEs) with up to 8 transmit antennas.

### BRIEF DESCRIPTION OF THE FIGURES

FIG. 1 illustrates an example of TPMIs for Rank-1 with two antenna ports in accordance with various embodiments.

FIG. 2 illustrates an example of TPMIs for Rank-2 with two antenna ports and CP-OFDM waveform in accordance with various embodiments.

FIG. 3 illustrates an example of TPMIs for Rank-1 with four antenna ports and DFT-s-OFDM waveform in accordance with various embodiments.

FIG. 4 illustrates an example of TPMIs for Rank-1 with four antenna ports and CP-OFDM waveform in accordance with various embodiments.

FIG. 5 illustrates an example of TPMIs for Rank-2 with four antenna ports and CP-OFDM waveform in accordance with various embodiments.

FIG. 6 illustrates an example of TPMIs for Rank-3 with four antenna ports and CP-OFDM waveform in accordance with various embodiments.

FIG. 7 illustrates an example of TPMIs for Rank-4 with four antenna ports and CP-OFDM waveform in accordance with various embodiments.

FIG. 8 depicts an example of antenna virtualization of eight transmit antennas to four antenna ports, in accordance with various embodiments.

FIG. 9 depicts an example of antenna virtualization of eight transmit antennas to six antenna ports, in accordance with various embodiments.

FIG. 10 illustrates a network in accordance with various embodiments.

FIG. 11 schematically illustrates a wireless network in accordance with various embodiments.

FIG. 12 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 13, 14, and 15 depict example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Various embodiments herein provide techniques for configuring and/or determining codebooks for different antenna structures, such as a user equipment (UE) with a non-uniform antenna array (e.g. with different distances between antenna elements) and/or multiple antenna panels. Embodiments further provide techniques for enhanced operation in full power mode 2. For example, embodiments provide techniques for antenna virtualization to form virtual antenna ports from subsets of transmit antennas of the UE (e.g., from eight transmit antennas to two, four, or six virtual antenna ports).

### Uplink Codebook for Different Antenna Structures

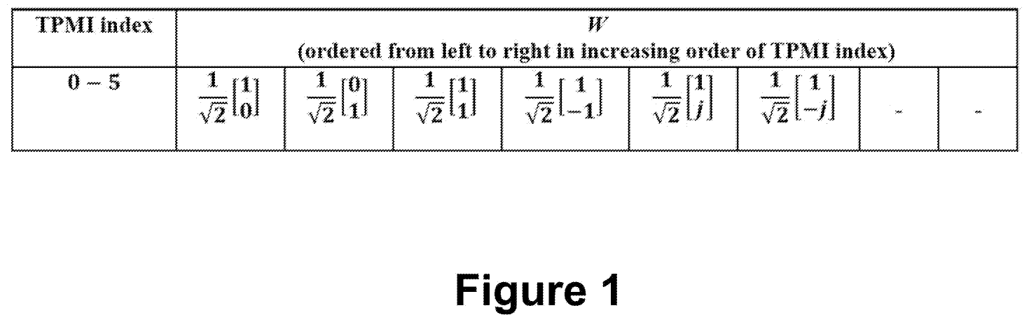

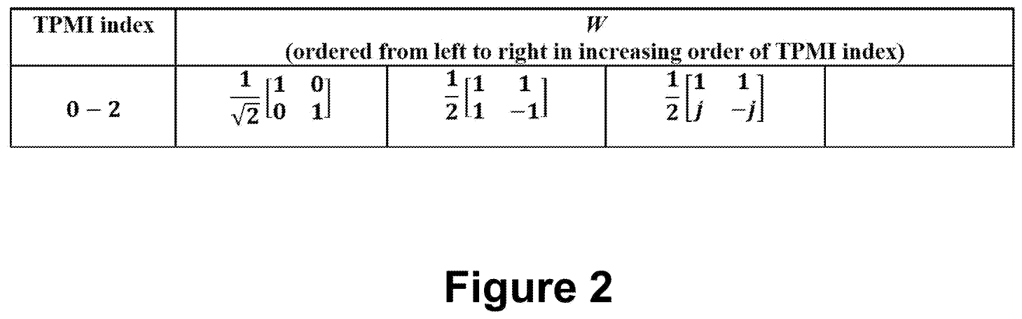

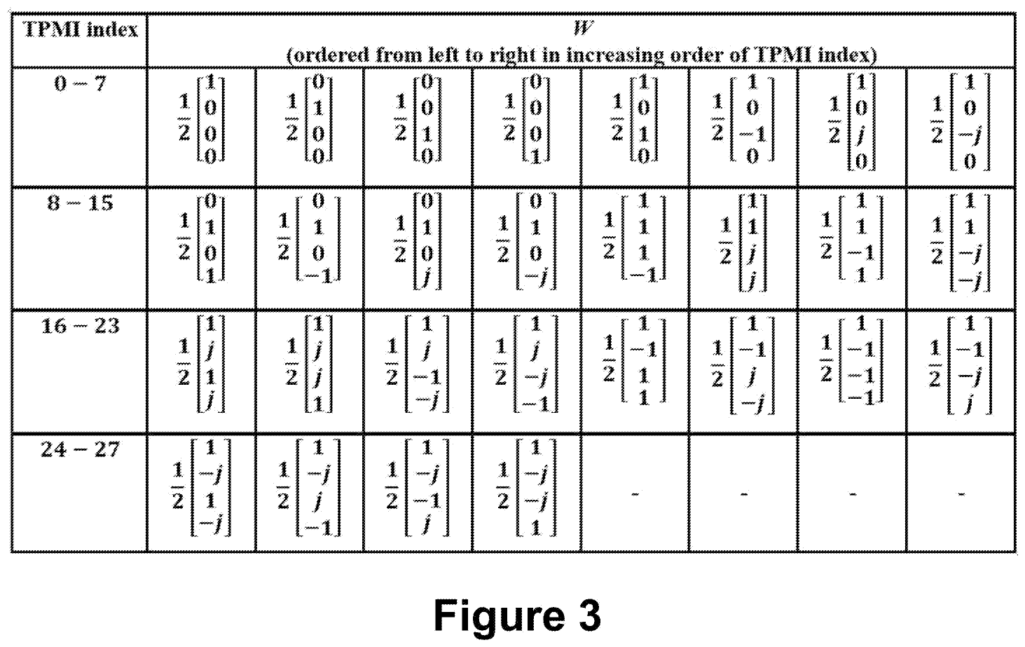

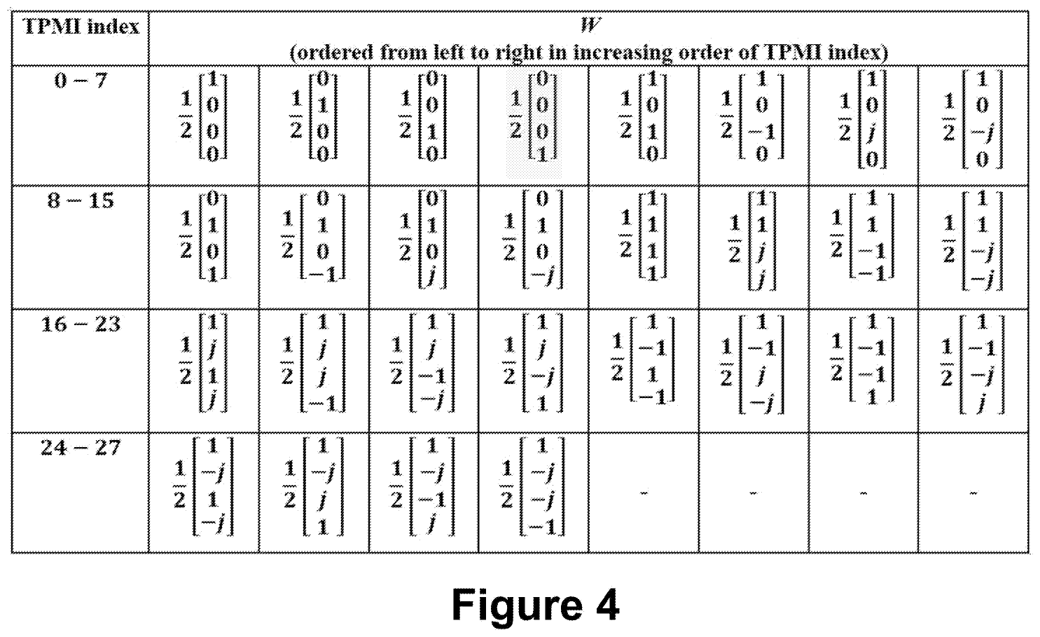

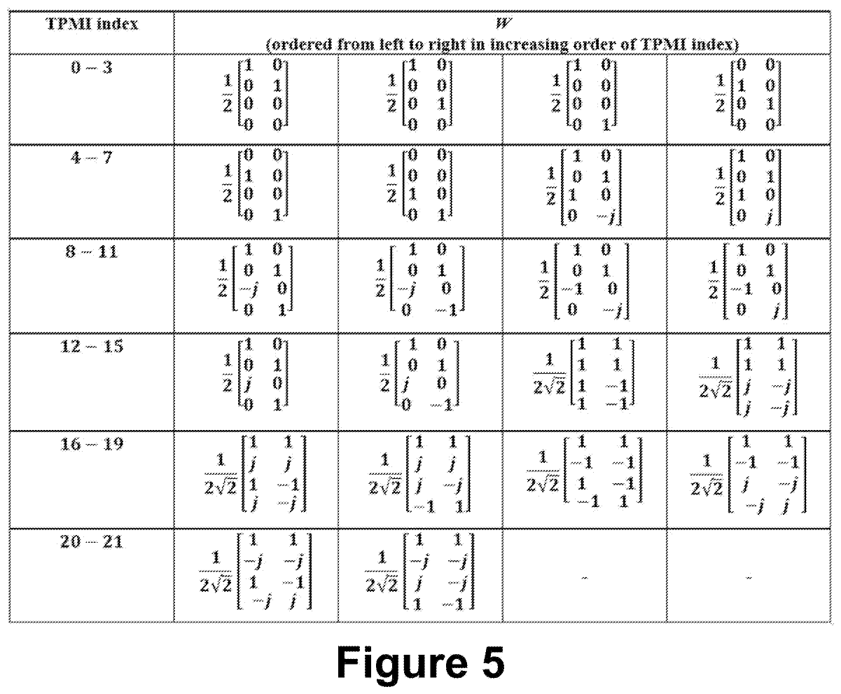

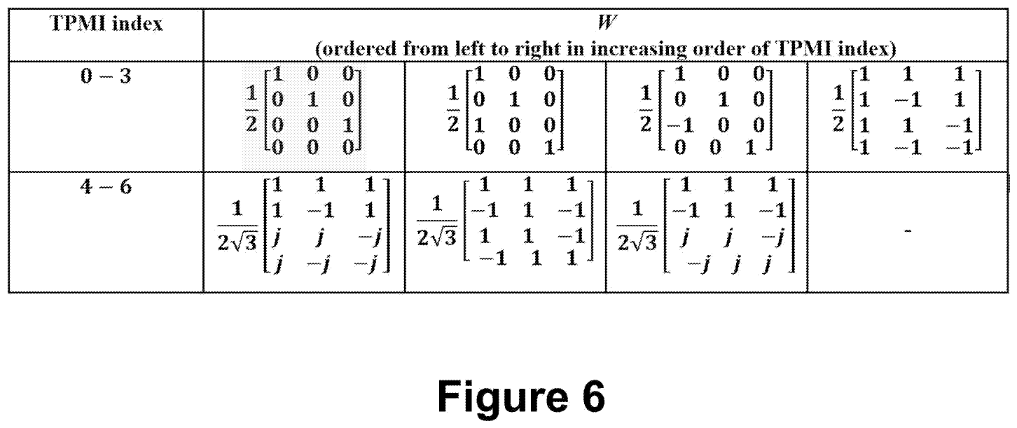

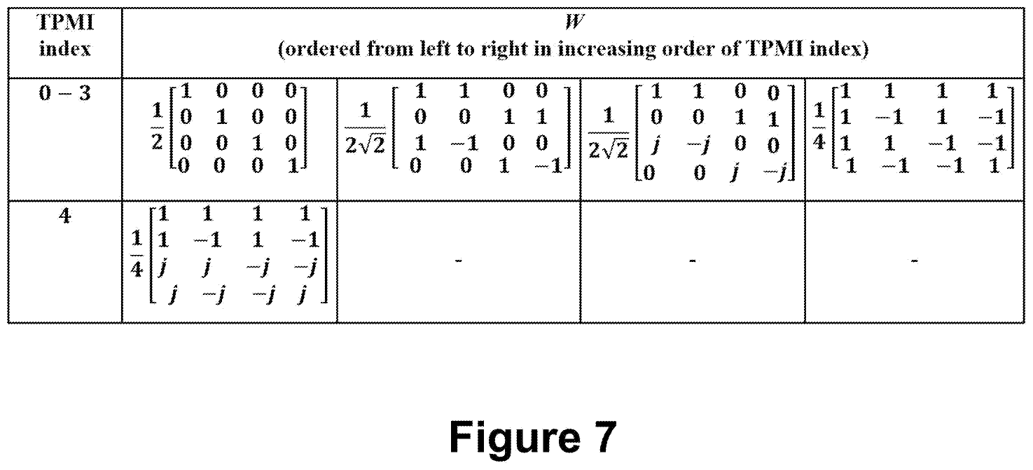

As discussed above, in prior versions of the 3GPP NR specifications, up to four layers are supported for PUSCH. The precoders (TPMIs) for uplink PUSCH transmission are defined in 3GPP TS 38.211, v. 17.1.0, 2022 Apr. 1-depending on the rank value (number of layers), number of antenna ports and waveform (CP-OFDM or DFT-s-OFDM), as shown in FIGS. 1 to 7. The codebooks are designed for a uniform antenna array, e.g., where the distance among antenna elements is the same.

However, in 3GPP Rel-18, different antenna structures may be used. For example, a UE may include a non-uniform antenna array (e.g., where the distance among antenna elements is different), multiple antenna panels, etc. Various embodiments herein may provide support (e.g., using codebooks for precoding matrixes for different antenna structures.

### Codebook for Non-Uniform Antenna Array

In an embodiment, for a non-uniform antenna array, the codebook could be generated according to the following equation:

$$W = {W}_{1} \times {W}_{2} \qquad ( Equation 1 )$$

where the matrix of W₁ represents the phase difference among antenna ports, and the matrix of W₂ is the precoder.

In one example, the size of W₁ could be N×N, N is the number of antenna ports and N∈ {2, 4, 8}. And the size of W₂ could be N×X, X is the number of layers and 1≤X≤N. In one example, the matrix of W₂ with 2-ports or 4-ports could be as shown in FIGS. 1 to 7.

In one example, the matrix of W₁ could be as shown in Equation (2), in which each column has a non-zero element e^{jΔ}^{ᵢ} and 1≤i≤N. The phase difference between the non-zero elements of two columns (#m, #n) represents the phase difference between two ports (#m, #n).

$$[ \begin{matrix}{e}^{j {Δ}_{1}} & 0 & … & 0 \\ 0 & {e}^{j {Δ}_{2}} & … & 0 \\ ⋮ & ⋮ & ⋱ & ⋮ \\ 0 & 0 & … & {e}^{j {Δ}_{N}}\end{matrix} ] \qquad ( Equation 2 )$$

The value of Δᵢ could be pre-defined/configured. Or the value of Δᵢ could be up to UE capability and UE should report the supported value(s) to gNB.

In another example, W₁ can be a block diagonal matrix where each block is associated with an antenna port group or an antenna panel, where each antenna port group or antenna panel may have an unequal number of ports. In this case, the entries of W₁ represents the inter-panel or inter-antenna-port group phase difference.

### Codebook for Multi-Panels/Codewords/Antenna Port Group

In an embodiment, for uplink transmissions, multiple panels/codewords could be used. Alternatively, or additionally, for uplink transmissions, one or more antenna port groups could be defined wherein each antenna port group includes one or multiple antenna ports. In some embodiments, the codebook could be generated according to Equation (3).

$$W = {W}_{1} ⊗ {W}_{2} \qquad ( Equation 3 )$$

where W₁ is the matrix for panel selection/codeword selection/antenna port group selection, W₂ is the precoder, and ⊗ means Kronecker product operation.

In one example, assuming the number of panels/codewords/antenna port groups is M, and M∈ {2, 4, 8}, the matrix of W₁ could be as shown by Equation (4):

$$[ \begin{matrix}{b}_{1} & 0 & … & 0 \\ 0 & {b}_{2} & … & 0 \\ ⋮ & ⋮ & ⋱ & ⋮ \\ 0 & 0 & … & {b}_{M}\end{matrix} ] \qquad ( Equation 4 )$$

where the value of bᵢ (1≤i≤M) could be bᵢ ∈ {0, 1}. In another example, the value of bᵢ could be bᵢ ∈ {0, 1, −1, j, −j}. The value of bᵢ in general can represent the inter-panel or inter-antenna port-group phase difference.

Assuming the number of antenna port within each panel/codeword/antenna port group is N, and N∈ {2, 4, 8}, the size of W₂ could be N×X, X is the number of layers and 1≤X≤N. In one example, the matrix of W₂ with 2-ports or 4-ports could be as shown from FIG. 1 to FIG. 7.

In another example, the matrix of W₁ could be as shown by Equation (5):

$$[ \begin{matrix}{b}_{1} & {b}_{2} & … & {b}_{M}\end{matrix} ] \qquad ( Equation 5 )$$

where the value of bᵢ (1≤i≤M) could be bᵢ ∈ {0, 1}. In another example, the value of bᵢ could be bᵢ ∈ {0, 1, −1, j, −j}.

In another embodiment, the codebook could be generated according to Equation (6).

$$W = [ \begin{matrix}{b}_{1} {W}_{1} & {b}_{2} {W}_{2} & … & {b}_{M} {W}_{M}\end{matrix} ] \qquad ( Equation 6 )$$

where the value of bᵢ (1≤i≤M) could be bᵢ ∈ {0, 1}. In another example, the value of bᵢ could be bᵢ ∈ {0, 1, −1, j, −j}. Assuming the number of antenna port within each panel/codeword/antenna port group is N, and N∈ {2, 4, 8}, Wᵢ is the precoder with N ports.

In another embodiment, the codebook could be generated according to Equation (7).

$$W = {W}_{1} \times {W}_{2} \qquad ( Equation 7 )$$

where W₁ is the matrix for antenna port selection, W₂ is the precoder. Assuming the number of antenna ports is N, and N∈ {2, 4, 8}, the size of W₁ could be N×N, the size of W₂ could be N×X, X is the number of layers and 1≤X≤N.

In one example, the matrix of W₁ could be as shown by Equation (8):

$$[ \begin{matrix}{b}_{1} & 0 & … & 0 \\ 0 & {b}_{2} & … & 0 \\ ⋮ & ⋮ & ⋱ & ⋮ \\ 0 & 0 & … & {b}_{N}\end{matrix} ] \qquad ( Equation 8 )$$

where the value of bᵢ (1≤i≤M) could be bᵢ ∈ {0, 1}. In another example, the value of bᵢ could be bᵢ € {0, 1, −1, j, −j}.

In another embodiment, the codebook could be generated according to Equation (9).

$$W = {W}_{1} ⊗ {W}_{2} \qquad ( Equation 9 )$$

When the number of panels/codewords/antenna port groups is 2, W₁ could be a 2-port precoder, and W₂ could be a 4-port precoder (or W₁ could be a 4-port precoder, and W₂ could be a 2-port precoder). The 2-port matrix represents whether UE can maintain relative phase among the panels/codewords/antenna port groups.

When the number of panels/codewords/antenna port groups is 4, W₁ could be a 4-port precoder, and W₂ could be a 2-port precoder (or W₁ could be a 2-port precoder, and W₂ could be a 4-port precoder). The 4-port matrix represents whether UE can maintain relative phase among the panels/codewords/antenna port groups. The precoder of 2-ports or 4-ports could be as shown from FIG. 1 to FIG. 7.

In another embodiment, the UE should report its coherence capability across panels/codewords/antenna port groups, e.g., whether relative phase can be maintained across panels/codewords/antenna port groups. The UE can also report full power capability across panels/codewords/antenna port groups.

In another embodiment, for multiple panels/codewords/antenna port groups, in the downlink control information (DCI) scheduling PUSCH, multiple TPMI fields could be included, e.g., 2 TPMI fields, and one TPMI field for each panel/codeword/antenna port group. If the max rank value is less than or equal to 4, then only the first TPMI field is used and the second TPMI field will be ignored. If the max rank value is larger than 4, then both TPMI fields are used.

In another embodiment, the codebook could be generated according to Equation (10).

$$W = {W}_{1} \times {W}_{2} \qquad ( Equation 10 )$$

In one example, W₁ could be a block diagonal matrix, such as

$$[ \begin{matrix}{B}_{1} & 0 \\ 0 & {B}_{2}\end{matrix} ] ,$$

where B₁ and B₂ could be the same or different.

In some embodiments, in the DCI scheduling PUSCH, new field(s) may be added to indicate the UE how to generate W₁ and W₂. In an example, the new field(s) could be jointly encoded with different max rank values.

In an example, the new field(s) to indicate the codebook generation is applied to 8-port transmission. The existing TPMI field(s) is used for less than 8-port (e.g., 2-port, 4-port). For example, if the number of SRS ports configured for codebook based transmission is 8, then the new field(s) are present in DCI, and the existing TPMI field(s) are not present in DCI. If the number of SRS ports configured for codebook based transmission is less than 8-port (e.g., 2-port, 4-port), then the new field(s) are not present in DCI, and the existing TPMI field(s) are present in DCI.

For full power Mode 2 operation, when a different number of ports are configured for the SRS resources and the maximum number of SRS ports is 8, then both the existing TPMI field(s) and the new field(s) may be present in DCI. And the field length of the existing TPMI field(s) is determined by the maximum number of SRS ports which is less than 8. For example, if 8-port, 4-port and 2-port are configured for SRS, then both TPMI field(s) and the new field(s) are included in the DCI, and the field length of the existing TPMI field(s) is determined by 4-port.

In another example, both the existing TPMI field(s) and the new field(s) are always present in DCI.

Note: this embodiment can be applied to single panel/codeword/antenna port group case and multiple panels/codewords/antenna port groups case. The DCI indication for codebook generation could also be applied to the codebook based on Equation (1) to Equation (9).

### Enhanced Operation for Full Power Mode 2

In the 3GPP Rel-16 specifications, full power operation is supported including full power Mode 0, full power Mode 1, and full power Mode 2. For full power Mode 2, the user equipment (UE) may perform antenna virtualization. For example, the UE with 4 transmit antennas (4Tx) could be virtualized to 2 ports, e.g., two transmit antennas form one port. In this way, the UE could perform the 2-port transmission. In the 3GPP release-18 (Rel-18) specifications, the UE could support uplink transmission with up to 8 transmit antennas (8Tx). Embodiments herein may provide techniques for antenna virtualization for full power mode 2 for a UE with 8 transmit antennas.

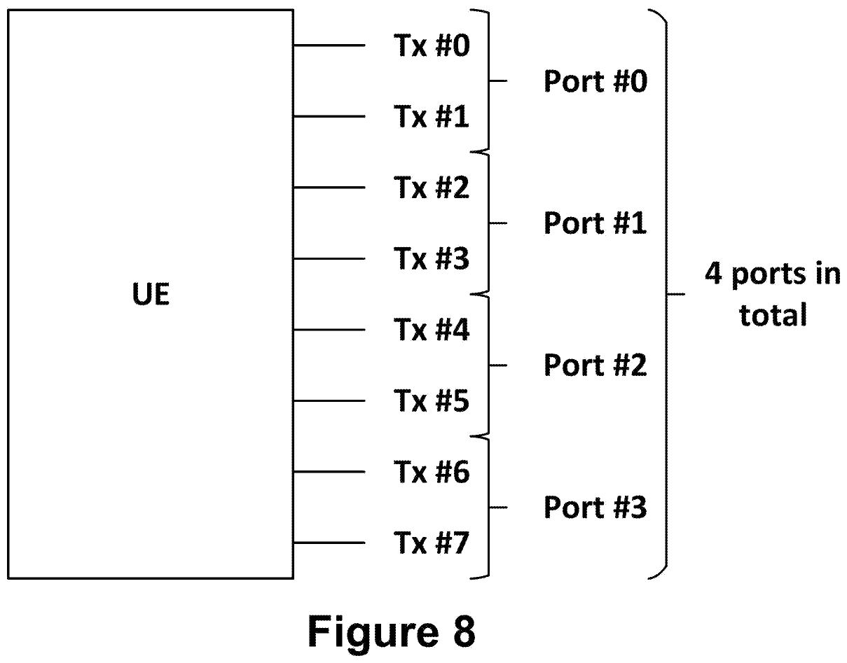

In an embodiment, for a UE with 8Tx, antenna virtualization may be performed for full power Mode 2. In an example, the 8Tx may be virtualized to 2 ports (e.g., the signal from 4Tx forms one port) or 4 ports (e.g., the signal from 2Tx forms one port). FIG. 8 shows an example of antenna virtualization to 4 ports.

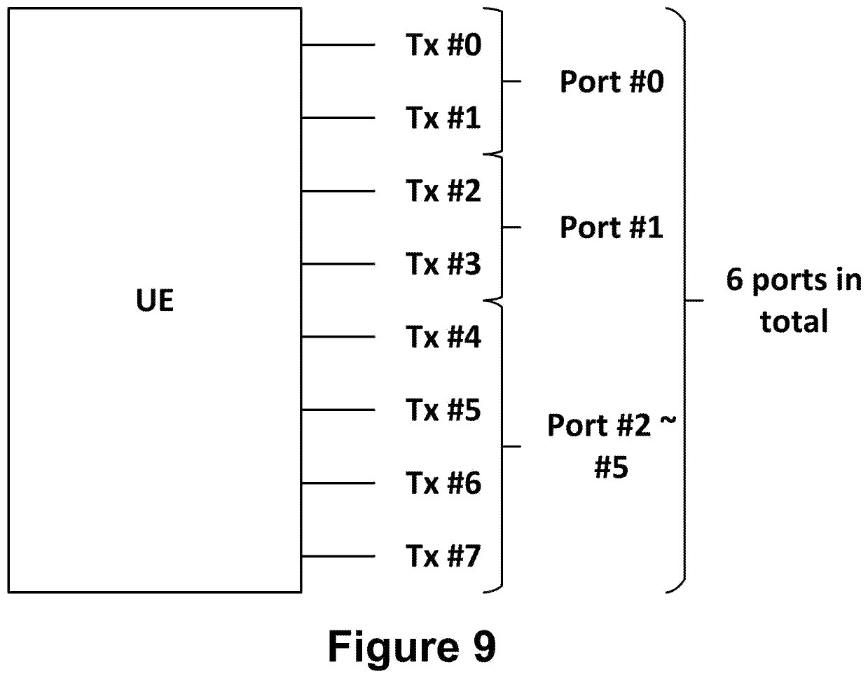

In another example, the 8Tx could be virtualized to 6 ports. For example, the signal from the first 4Tx forms 2 ports, and the remaining 4Tx corresponds to 4 ports. FIG. 9 shows an example of antenna virtualization to 6 ports.

In another embodiment, for a UE with 8Tx and full power Mode 2, the number of ports that are formed by antenna virtualization may be based on (e.g., up to) UE capability. In some embodiments, the UE capability may be indicated to the network (e.g., gNB).

In another embodiment, for a UE with multiple panels/codewords/antenna port groups, the antenna virtualization for full power Mode 2 may not be performed across different panels/codewords/antenna port groups. The total number of Tx of the UE is larger than 1, e.g., 2Tx/4Tx/6Tx/8Tx.

In another embodiment, for a UE with multiple panels/codewords/antenna port groups, the antenna virtualization for full power Mode 2 may be performed across different panels/codewords/antenna port groups. The total number of Tx of the UE is larger than 1, e.g., 2Tx/4Tx/6Tx/8Tx.

In another embodiment, whether antenna virtualization for full power Mode 2 may be performed across different panels/codewords/antenna port groups could be up to UE capability. In some embodiments, the UE capability may be indicated to the network (e.g., gNB).

### Systems and Implementations

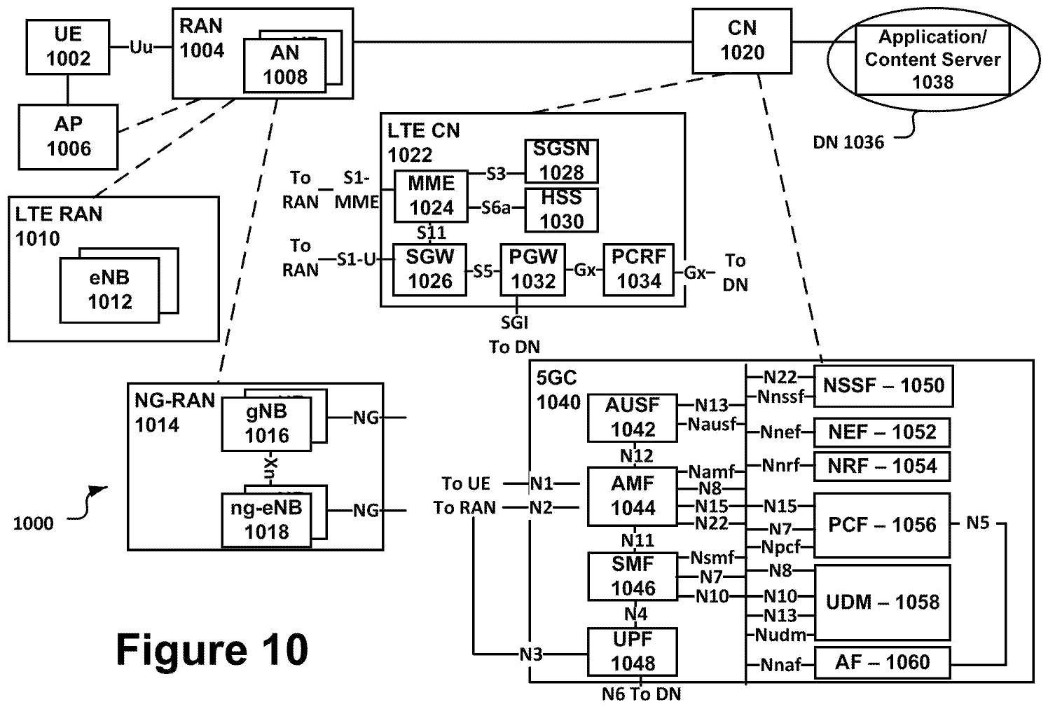

FIGS. 10-12 illustrate various systems, devices, and components that may implement aspects of disclosed embodiments.

FIG. 10 illustrates a network 1000 in accordance with various embodiments. The network 1000 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1000 may include a UE 1002, which may include any mobile or non-mobile computing device designed to communicate with a RAN 1004 via an over-the-air connection. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1002 may additionally communicate with an AP 1006 via an over-the-air connection. The AP 1006 may manage a WLAN connection, which may serve to offload some/all network traffic from the RAN 1004. The connection between the UE 1002 and the AP 1006 may be consistent with any IEEE 802.11 protocol, wherein the AP 1006 could be a wireless fidelity (Wᵢ-Fi®) router. In some embodiments, the UE 1002, RAN 1004, and AP 1006 may utilize cellular-WLAN aggregation (for example, LWA/LWIP). Cellular-WLAN aggregation may involve the UE 1002 being configured by the RAN 1004 to utilize both cellular radio resources and WLAN resources.

The RAN 1004 may include one or more access nodes, for example, AN 1008. AN 1008 may terminate air-interface protocols for the UE 1002 by providing access stratum protocols including RRC, PDCP, RLC, MAC, and L1 protocols. In this manner, the AN 1008 may enable data/voice connectivity between CN 1020 and the UE 1002. In some embodiments, the AN 1008 may be implemented in a discrete device or as one or more software entities running on server computers as part of, for example, a virtual network, which may be referred to as a CRAN or virtual baseband unit pool. The AN 1008 be referred to as a BS, gNB, RAN node, eNB, ng-eNB, NodeB, RSU, TRxP, TRP, etc. The AN 1008 may be a macrocell base station or a low power base station for providing femtocells, picocells or other like cells having smaller coverage areas, smaller user capacity, or higher bandwidth compared to macrocells.

In embodiments in which the RAN 1004 includes a plurality of ANs, they may be coupled with one another via an X2 interface (if the RAN 1004 is an LTE RAN) or an Xn interface (if the RAN 1004 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1004 may each manage one or more cells, cell groups, component carriers, etc. to provide the UE 1002 with an air interface for network access. The UE 1002 may be simultaneously connected with a plurality of cells provided by the same or different ANs of the RAN 1004. For example, the UE 1002 and RAN 1004 may use carrier aggregation to allow the UE 1002 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1004 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1002 or AN 1008 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1004 may be an LTE RAN 1010 with eNBs, for example, eNB 1012. The LTE RAN 1010 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1004 may be an NG-RAN 1014 with gNBs, for example, gNB 1016, or ng-eNBs, for example, ng-eNB 1018. The gNB 1016 may connect with 5G-enabled UEs using a 5G NR interface. The gNB 1016 may connect with a 5G core through an NG interface, which may include an N2 interface or an N3 interface. The ng-eNB 1018 may also connect with the 5G core through an NG interface, but may connect with a UE via an LTE air interface. The gNB 1016 and the ng-eNB 1018 may connect with each other over an Xn interface.

In some embodiments, the NG interface may be split into two parts, an NG user plane (NG-U) interface, which carries traffic data between the nodes of the NG-RAN 1014 and a UPF 1048 (e.g., N3 interface), and an NG control plane (NG-C) interface, which is a signaling interface between the nodes of the NG-RAN 1014 and an AMF 1044 (e.g., N2 interface).

The NG-RAN 1014 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1002 can be configured with multiple BWPs where each BWP configuration has a different SCS. When a BWP change is indicated to the UE 1002, the SCS of the transmission is changed as well. Another use case example of BWP is related to power saving. In particular, multiple BWPs can be configured for the UE 1002 with different amount of frequency resources (for example, PRBs) to support data transmission under different traffic loading scenarios. A BWP containing a smaller number of PRBs can be used for data transmission with small traffic load while allowing power saving at the UE 1002 and in some cases at the gNB 1016. A BWP containing a larger number of PRBs can be used for scenarios with higher traffic load.

The RAN 1004 is communicatively coupled to CN 1020 that includes network elements to provide various functions to support data and telecommunications services to customers/subscribers (for example, users of UE 1002). The components of the CN 1020 may be implemented in one physical node or separate physical nodes. In some embodiments, NFV may be utilized to virtualize any or all of the functions provided by the network elements of the CN 1020 onto physical compute/storage resources in servers, switches, etc. A logical instantiation of the CN 1020 may be referred to as a network slice, and a logical instantiation of a portion of the CN 1020 may be referred to as a network sub-slice.

In some embodiments, the CN 1020 may be an LTE CN 1022, which may also be referred to as an EPC. The LTE CN 1022 may include MME 1024, SGW 1026, SGSN 1028, HSS 1030, PGW 1032, and PCRF 1034 coupled with one another over interfaces (or “reference points”) as shown. Functions of the elements of the LTE CN 1022 may be briefly introduced as follows.

The MME 1024 may implement mobility management functions to track a current location of the UE 1002 to facilitate paging, bearer activation/deactivation, handovers, gateway selection, authentication, etc.

The SGW 1026 may terminate an SI interface toward the RAN and route data packets between the RAN and the LTE CN 1022. The SGW 1026 may be a local mobility anchor point for inter-RAN node handovers and also may provide an anchor for inter-3GPP mobility. Other responsibilities may include lawful intercept, charging, and some policy enforcement.

The SGSN 1028 may track a location of the UE 1002 and perform security functions and access control. In addition, the SGSN 1028 may perform inter-EPC node signaling for mobility between different RAT networks; PDN and S-GW selection as specified by MME 1024; MME selection for handovers; etc. The S3 reference point between the MME 1024 and the SGSN 1028 may enable user and bearer information exchange for inter-3GPP access network mobility in idle/active states.

The HSS 1030 may include a database for network users, including subscription-related information to support the network entities' handling of communication sessions. The HSS 1030 can provide support for routing/roaming, authentication, authorization, naming/addressing resolution, location dependencies, etc. An S6a reference point between the HSS 1030 and the MME 1024 may enable transfer of subscription and authentication data for authenticating/authorizing user access to the LTE CN 1020.

The PGW 1032 may terminate an SGi interface toward a data network (DN) 1036 that may include an application/content server 1038. The PGW 1032 may route data packets between the LTE CN 1022 and the data network 1036. The PGW 1032 may be coupled with the SGW 1026 by an S5 reference point to facilitate user plane tunneling and tunnel management. The PGW 1032 may further include a node for policy enforcement and charging data collection (for example, PCEF). Additionally, the SGi reference point between the PGW 1032 and the data network 1036 may be an operator external public, a private PDN, or an intra-operator packet data network, for example, for provision of IMS services. The PGW 1032 may be coupled with a PCRF 1034 via a Gx reference point.

The PCRF 1034 is the policy and charging control element of the LTE CN 1022. The PCRF 1034 may be communicatively coupled to the app/content server 1038 to determine appropriate QoS and charging parameters for service flows. The PCRF 1032 may provision associated rules into a PCEF (via Gx reference point) with appropriate TFT and QCI.

In some embodiments, the CN 1020 may be a 5GC 1040. The 5GC 1040 may include an AUSF 1042, AMF 1044, SMF 1046, UPF 1048, NSSF 1050, NEF 1052, NRF 1054, PCF 1056, UDM 1058, and AF 1060 coupled with one another over interfaces (or “reference points”) as shown. Functions of the elements of the 5GC 1040 may be briefly introduced as follows.

The AUSF 1042 may store data for authentication of UE 1002 and handle authentication-related functionality. The AUSF 1042 may facilitate a common authentication framework for various access types. In addition to communicating with other elements of the 5GC 1040 over reference points as shown, the AUSF 1042 may exhibit an Nausf service-based interface.

The AMF 1044 may allow other functions of the 5GC 1040 to communicate with the UE 1002 and the RAN 1004 and to subscribe to notifications about mobility events with respect to the UE 1002. The AMF 1044 may be responsible for registration management (for example, for registering UE 1002), connection management, reachability management, mobility management, lawful interception of AMF-related events, and access authentication and authorization. The AMF 1044 may provide transport for SM messages between the UE 1002 and the SMF 1046, and act as a transparent proxy for routing SM messages. AMF 1044 may also provide transport for SMS messages between UE 1002 and an SMSF. AMF 1044 may interact with the AUSF 1042 and the UE 1002 to perform various security anchor and context management functions. Furthermore, AMF 1044 may be a termination point of a RAN CP interface, which may include or be an N2 reference point between the RAN 1004 and the AMF 1044; and the AMF 1044 may be a termination point of NAS (N1) signaling, and perform NAS ciphering and integrity protection. AMF 1044 may also support NAS signaling with the UE 1002 over an N3 IWF interface.

The SMF 1046 may be responsible for SM (for example, session establishment, tunnel management between UPF 1048 and AN 1008); UE IP address allocation and management (including optional authorization); selection and control of UP function; configuring traffic steering at UPF 1048 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 1044 over N2 to AN 1008; and determining SSC mode of a session. SM may refer to management of a PDU session, and a PDU session or “session” may refer to a PDU connectivity service that provides or enables the exchange of PDUs between the UE 1002 and the data network 1036.

The UPF 1048 may act as an anchor point for intra-RAT and inter-RAT mobility, an external PDU session point of interconnect to data network 1036, and a branching point to support multi-homed PDU session. The UPF 1048 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1048 may include an uplink classifier to support routing traffic flows to a data network.

The NSSF 1050 may select a set of network slice instances serving the UE 1002. The NSSF 1050 may also determine allowed NSSAI and the mapping to the subscribed S-NSSAIs, if needed. The NSSF 1050 may also determine the AMF set to be used to serve the UE 1002, or a list of candidate AMFs based on a suitable configuration and possibly by querying the NRF 1054. The selection of a set of network slice instances for the UE 1002 may be triggered by the AMF 1044 with which the UE 1002 is registered by interacting with the NSSF 1050, which may lead to a change of AMF. The NSSF 1050 may interact with the AMF 1044 via an N22 reference point; and may communicate with another NSSF in a visited network via an N31 reference point (not shown). Additionally, the NSSF 1050 may exhibit an Nnssf service-based interface.

The NEF 1052 may securely expose services and capabilities provided by 3GPP network functions for third party, internal exposure/re-exposure, AFs (e.g., AF 1060), edge computing or fog computing systems, etc. In such embodiments, the NEF 1052 may authenticate, authorize, or throttle the AFs. NEF 1052 may also translate information exchanged with the AF 1060 and information exchanged with internal network functions. For example, the NEF 1052 may translate between an AF-Service-Identifier and an internal 5GC information. NEF 1052 may also receive information from other NFs based on exposed capabilities of other NFs. This information may be stored at the NEF 1052 as structured data, or at a data storage NF using standardized interfaces. The stored information can then be re-exposed by the NEF 1052 to other NFs and AFs, or used for other purposes such as analytics. Additionally, the NEF 1052 may exhibit an Nnef service-based interface.

The NRF 1054 may support service discovery functions, receive NF discovery requests from NF instances, and provide the information of the discovered NF instances to the NF instances. NRF 1054 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1054 may exhibit the Nnrf service-based interface.

The PCF 1056 may provide policy rules to control plane functions to enforce them, and may also support unified policy framework to govern network behavior. The PCF 1056 may also implement a front end to access subscription information relevant for policy decisions in a UDR of the UDM 1058. In addition to communicating with functions over reference points as shown, the PCF 1056 exhibit an Npcf service-based interface.

The UDM 1058 may handle subscription-related information to support the network entities' handling of communication sessions, and may store subscription data of UE 1002. For example, subscription data may be communicated via an N8 reference point between the UDM 1058 and the AMF 1044. The UDM 1058 may include two parts, an application front end and a UDR. The UDR may store subscription data and policy data for the UDM 1058 and the PCF 1056, and/or structured data for exposure and application data (including PFDs for application detection, application request information for multiple UEs 1002) for the NEF 1052. The Nudr service-based interface may be exhibited by the UDR 221 to allow the UDM 1058, PCF 1056, and NEF 1052 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1058 may exhibit the Nudm service-based interface.

The AF 1060 may provide application influence on traffic routing, provide access to NEF, and interact with the policy framework for policy control.

In some embodiments, the 5GC 1040 may enable edge computing by selecting operator/3^{rd} party services to be geographically close to a point that the UE 1002 is attached to the network. This may reduce latency and load on the network. To provide edge-computing implementations, the 5GC 1040 may select a UPF 1048 close to the UE 1002 and execute traffic steering from the UPF 1048 to data network 1036 via the N6 interface. This may be based on the UE subscription data, UE location, and information provided by the AF 1060. In this way, the AF 1060 may influence UPF (re) selection and traffic routing. Based on operator deployment, when AF 1060 is considered to be a trusted entity, the network operator may permit AF 1060 to interact directly with relevant NFs. Additionally, the AF 1060 may exhibit an Naf service-based interface.

The data network 1036 may represent various network operator services, Internet access, or third party services that may be provided by one or more servers including, for example, application/content server 1038.

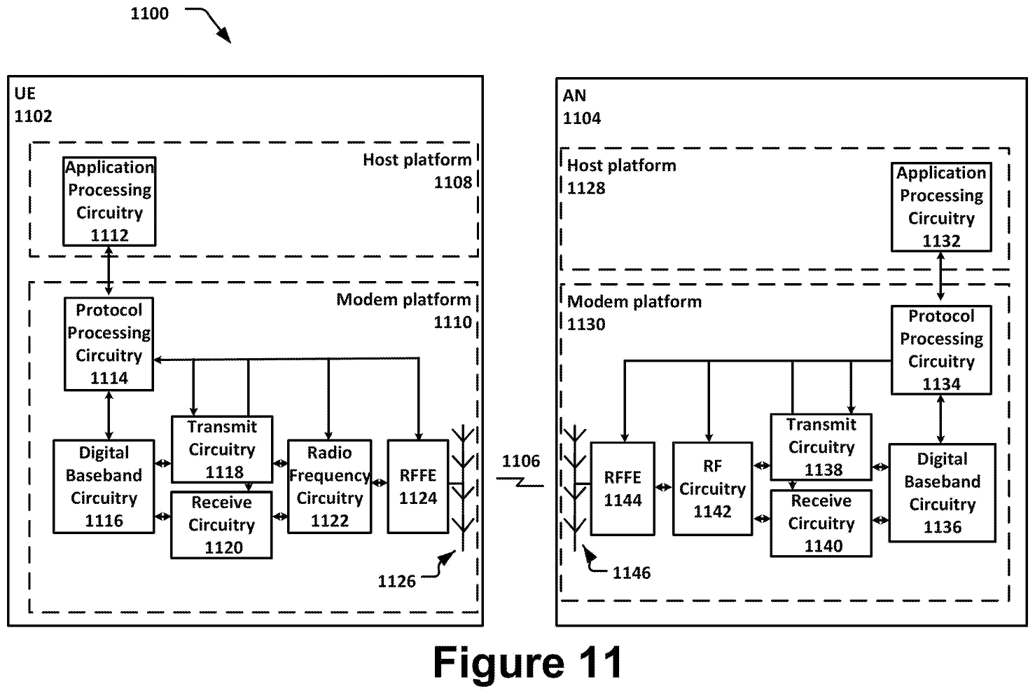

FIG. 11 schematically illustrates a wireless network 1100 in accordance with various embodiments. The wireless network 1100 may include a UE 1102 in wireless communication with an AN 1104. The UE 1102 and AN 1104 may be similar to, and substantially interchangeable with, like-named components described elsewhere herein.

The UE 1102 may be communicatively coupled with the AN 1104 via connection 1106. The connection 1106 is illustrated as an air interface to enable communicative coupling, and can be consistent with cellular communications protocols such as an LTE protocol or a 5G NR protocol operating at mm Wave or sub-6 GHZ frequencies.

The UE 1102 may include a host platform 1108 coupled with a modem platform 1110. The host platform 1108 may include application processing circuitry 1112, which may be coupled with protocol processing circuitry 1114 of the modem platform 1110. The application processing circuitry 1112 may run various applications for the UE 1102 that source/sink application data. The application processing circuitry 1112 may further implement one or more layer operations to transmit/receive application data to/from a data network. These layer operations may include transport (for example UDP) and Internet (for example, IP) operations

The protocol processing circuitry 1114 may implement one or more of layer operations to facilitate transmission or reception of data over the connection 1106. The layer operations implemented by the protocol processing circuitry 1114 may include, for example, MAC, RLC, PDCP, RRC and NAS operations.

The modem platform 1110 may further include digital baseband circuitry 1116 that may implement one or more layer operations that are “below” layer operations performed by the protocol processing circuitry 1114 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1110 may further include transmit circuitry 1118, receive circuitry 1120, RF circuitry 1122, and RF front end (RFFE) 1124, which may include or connect to one or more antenna panels 1126. Briefly, the transmit circuitry 1118 may include a digital-to-analog converter, mixer, intermediate frequency (IF) components, etc.; the receive circuitry 1120 may include an analog-to-digital converter, mixer, IF components, etc.; the RF circuitry 1122 may include a low-noise amplifier, a power amplifier, power tracking components, etc.; RFFE 1124 may include filters (for example, surface/bulk acoustic wave filters), switches, antenna tuners, beamforming components (for example, phase-array antenna components), etc. The selection and arrangement of the components of the transmit circuitry 1118, receive circuitry 1120, RF circuitry 1122, RFFE 1124, and antenna panels 1126 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1114 may include one or more instances of control circuitry (not shown) to provide control functions for the transmit/receive components.

A UE reception may be established by and via the antenna panels 1126, RFFE 1124, RF circuitry 1122, receive circuitry 1120, digital baseband circuitry 1116, and protocol processing circuitry 1114. In some embodiments, the antenna panels 1126 may receive a transmission from the AN 1104 by receive-beamforming signals received by a plurality of antennas/antenna elements of the one or more antenna panels 1126.

A UE transmission may be established by and via the protocol processing circuitry 1114, digital baseband circuitry 1116, transmit circuitry 1118, RF circuitry 1122, RFFE 1124, and antenna panels 1126. In some embodiments, the transmit components of the UE 1104 may apply a spatial filter to the data to be transmitted to form a transmit beam emitted by the antenna elements of the antenna panels 1126.

Similar to the UE 1102, the AN 1104 may include a host platform 1128 coupled with a modem platform 1130. The host platform 1128 may include application processing circuitry 1132 coupled with protocol processing circuitry 1134 of the modem platform 1130. The modem platform may further include digital baseband circuitry 1136, transmit circuitry 1138, receive circuitry 1140, RF circuitry 1142, RFFE circuitry 1144, and antenna panels 1146. The components of the AN 1104 may be similar to and substantially interchangeable with like-named components of the UE 1102. In addition to performing data transmission/reception as described above, the components of the AN 1108 may perform various logical functions that include, for example, RNC functions such as radio bearer management, uplink and downlink dynamic radio resource management, and data packet scheduling.

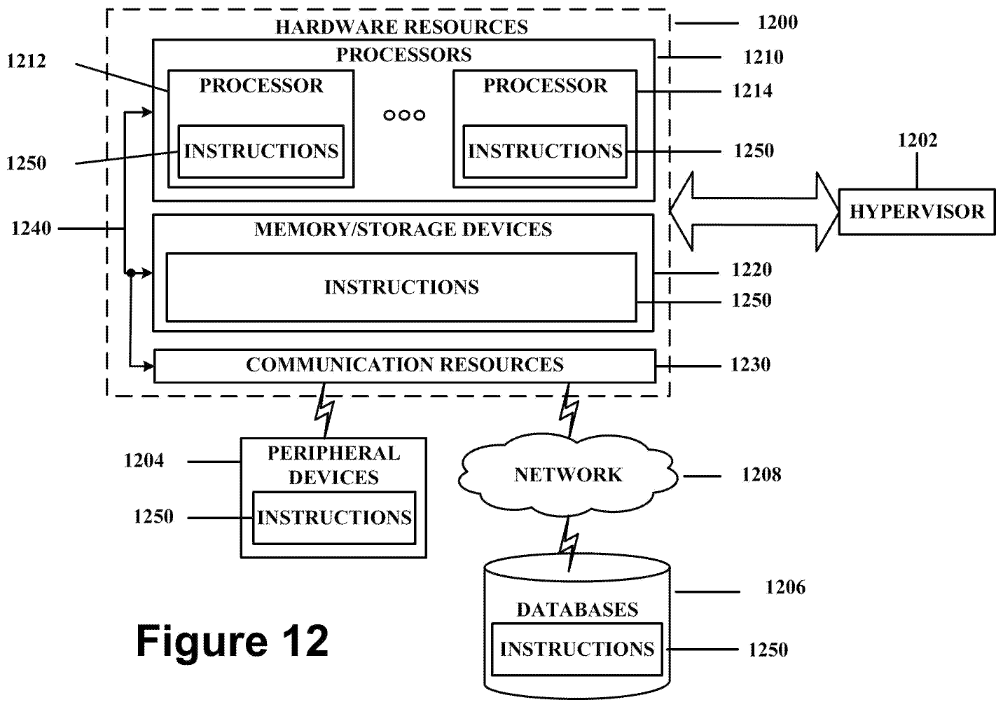

FIG. 12 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors (or processor cores) 1210, one or more memory/storage devices 1220, and one or more communication resources 1230, each of which may be communicatively coupled via a bus 1240 or other interface circuitry. For embodiments where node virtualization (e.g., NFV) is utilized, a hypervisor 1202 may be executed to provide an execution environment for one or more network slices/sub-slices to utilize the hardware resources 1200.

The processors 1210 may include, for example, a processor 1212 and a processor 1214. The processors 1210 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1220 may include main memory, disk storage, or any suitable combination thereof. The memory/storage devices 1220 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1230 may include interconnection or network interface controllers, components, or other suitable devices to communicate with one or more peripheral devices 1204 or one or more databases 1206 or other network elements via a network 1208. For example, the communication resources 1230 may include wired communication components (e.g., for coupling via USB, Ethernet, etc.), cellular communication components, NFC components, Bluetooth® (or Bluetooth® Low Energy) components, Wᵢ-Fi® components, and other communication components.

Instructions 1250 may comprise software, a program, an application, an applet, an app, or other executable code for causing at least any of the processors 1210 to perform any one or more of the methodologies discussed herein. The instructions 1250 may reside, completely or partially, within at least one of the processors 1210 (e.g., within the processor's cache memory), the memory/storage devices 1220, or any suitable combination thereof. Furthermore, any portion of the instructions 1250 may be transferred to the hardware resources 1200 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

### Example Procedures

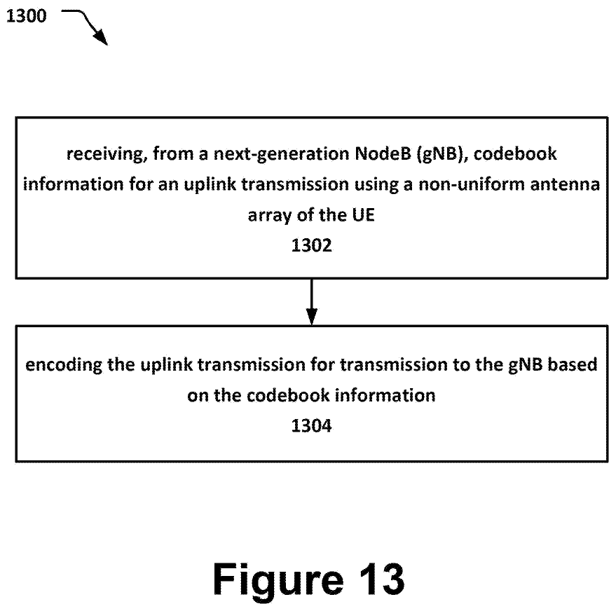

In some embodiments, the electronic device(s), network(s), system(s), chip(s) or component(s), or portions or implementations thereof, of FIGS. 10-12, or some other figure herein, may be configured to perform one or more processes, techniques, or methods as described herein, or portions thereof. One such process 1300 is depicted in FIG. 13. The process 1300 may be performed by a user equipment (UE), one or more elements of a UE, and/or an electronic device that includes a UE. At 1302, the process 1300 may include receiving, from a next-generation NodeB (gNB), codebook information for an uplink transmission using a non-uniform antenna array of the UE. At 1304, the process 1300 may further include encoding the uplink transmission for transmission to the gNB based on the codebook information.

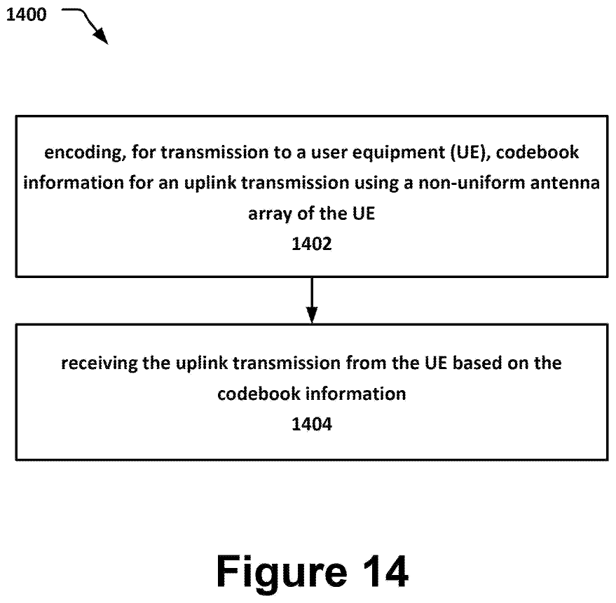

FIG. 14 illustrates another process 1400 in accordance with various embodiments. The process 1400 may be performed by a next generation Node B (gNB), one or more elements of a gNB, and/or an electronic device that includes a gNB. At 1402, the process 1400 may include encoding, for transmission to a user equipment (UE), codebook information for an uplink transmission using a non-uniform antenna array of the UE. At 1404, the process may further include receiving the uplink transmission from the UE based on the codebook information.

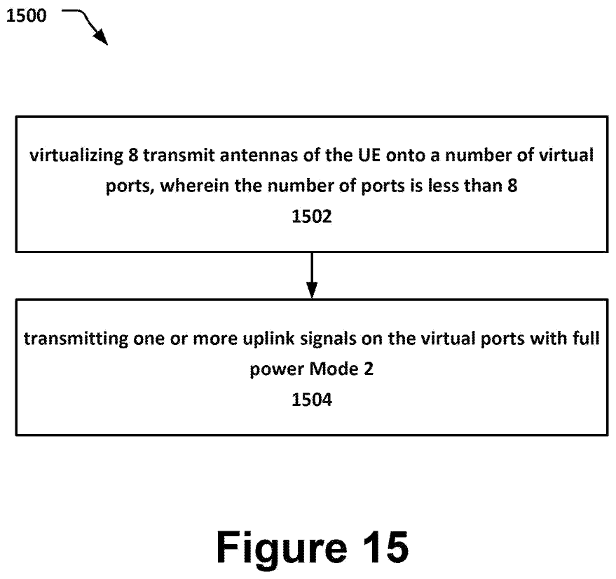

FIG. 15 illustrates another process 1500 in accordance with various embodiments. The process 1500 may be performed by a UE, one or more elements of a UE, and/or an electronic device that includes a UE. At 1502, the process 1500 may include virtualizing 8 transmit antennas of the UE onto a number of virtual ports, wherein the number of ports is less than 8. At 1504, the process 1500 may further include transmitting one or more uplink signals on the virtual ports with full power Mode 2.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A1 may include one or more non-transitory computer-readable media (NTCRM) having instructions, stored thereon, that when executed by one or more processors of a user equipment (UE) configure the UE to:
receive, from a next-generation NodeB (gNB), codebook information for an uplink transmission using a non-uniform antenna array of the UE; and
encode the uplink transmission for transmission to the gNB based on the codebook information.

Example A2 may include the one or more NTCRM of example A1, wherein the codebook information is based on a matrix representing a phase difference between antenna ports and a precoder matrix.

Example A3 may include the one or more NTCRM of example A2, wherein the matrix includes one or more entries representing an inter-panel or inter-antenna-port group phase difference.

Example A4 may include the one or more NTCRM of example A1, wherein the codebook information includes an indication of a block diagonal matrix for generating a codebook.

Example A5 may include the one or more NTCRM of example A1, wherein the codebook information is associated with one or more of: multiple antenna panels, multiple codewords, or one or more antenna port groups that include multiple antenna ports.

Example A6 may include the one or more NTCRM of example A1, wherein the instructions, when executed, further configure the UE to encode a message for transmission to the gNB that includes an indication of a coherence capability of the UE across one or more antenna panels, codewords, or antenna port groups.

Example A7 may include the one or more NTCRM of example A1, wherein the instructions, when executed, further configure the UE to encode a message for transmission to the gNB that includes an indication of a full power capability across one or more panels, codewords, or antenna port groups.

Example A8 may include the one or more NTCRM of any one of examples A1-A7, wherein the non-uniform antenna array includes a plurality of antenna elements with unequal spacing between adjacent antenna elements of the plurality of antenna elements.

Example A9 may include one or more non-transitory computer-readable media (NTCRM) having instructions, stored thereon, that when executed by one or more processors of a next generation Node B (gNB) configure the gNB to:
encode, for transmission to a user equipment (UE), codebook information for an uplink transmission using a non-uniform antenna array of the UE; and
receive the uplink transmission from the UE based on the codebook information.

Example A10 may include the one or more NTCRM of example A9, wherein the codebook information is based on a matrix representing a phase difference between antenna ports and a precoder matrix.

Example A11 may include the one or more NTCRM of example A10, wherein the matrix includes one or more entries representing an inter-panel or inter-antenna-port group phase difference.

Example A12 may include the one or more NTCRM of example A9, wherein the codebook information includes an indication of a block diagonal matrix for generating a codebook.

Example A13 may include the one or more NTCRM of example A9, wherein the codebook information is associated with one or more of: multiple antenna panels, multiple codewords, or one or more antenna port groups that include multiple antenna ports.

Example A14 may include the one or more NTCRM of example A9, wherein the instructions, when executed, further configure the gNB to receive, from the UE, an indication of a coherence capability of the UE across one or more antenna panels, codewords, or antenna port groups, wherein the codebook information is based on the indication.

Example A15 may include the one or more NTCRM of example A9, wherein the instructions, when executed, further configure the gNB to receive an indication of a full power capability across one or more panels, codewords, or antenna port groups, wherein the codebook information is based on the indication.

Example A16 may include the one or more NTCRM of any one of examples A9-A15, wherein the non-uniform antenna array includes a plurality of antenna elements with unequal spacing between adjacent antenna elements of the plurality of antenna elements.

Example A17 may include one or more non-transitory computer-readable media (NTCRM) having instructions, stored thereon, that when executed by one or more processors of a user equipment (UE) configure the UE to:
virtualize 8 transmit antennas of the UE onto a number of virtual ports, wherein the number of ports is less than 8; and
transmit one or more uplink signals on the virtual ports with full power Mode 2.

Example A18 may include the one or more NTCRM of example A17, wherein the number of virtual ports is 4, and wherein pairs of the transmit antennas are virtualized onto the respective virtual ports.

Example A19 may include the one or more NTCRM of example A17, wherein the number of virtual ports is 2, and wherein 2 sets of 4 of the transmit antennas are virtualized onto the respective virtual ports.

Example A20 may include the one or more NTCRM of example A17, wherein the number of virtual ports is 6, wherein a first 2 of the transmit antennas are virtualized onto a first virtual port, a second 2 of the transmit antennas are virtualized onto a second virtual port, and 4 of the transmit antennas are virtualized onto a respective individual virtual ports.

Example A21 may include the one or more NTCRM of example A17, wherein the number of virtual ports is based on a UE capability.

Example A22 may include the one or more NTCRM of any one of examples A17-A21, wherein the virtualization is performed across different antenna panels, codewords, or antenna port groups.

Example B1 may include a method of operating a wireless network that includes a next-generation NodeB (gNB), wherein the gNB is adapted to configure a user equipment (UE) for a physical uplink shared channel (PUSCH) transmission.

Example B2 may include the method of example B1 or some other example herein, wherein the UE is adapted to transmit PUSCH based on the codebook indicated by the gNB.

Example B3 may include the method of example B1 and example B2 or some other example herein, wherein for non-uniform antenna array, the codebook could be generated according to equation (1).

Example B4 may include the method of example B3 or some other example herein, wherein the matrix of W₁ represents the phase difference among antenna ports.

Example B5 may include the method of example B4 or some other example herein, wherein the matrix of W₁ could be as shown in Equation (2), in which each column has a non-zero element e^{jΔ}^{ᵢ} and 1≤i≤N. The phase difference between the non-zero elements of two columns (#m, #n) represents the phase difference between two ports (#m, #n). Or W₁ can be a block diagonal matrix where each block is associated with an antenna port group or an antenna panel, where each antenna port group or antenna panel may have an unequal number of ports. In this case, the entries of W₁ represents the inter-panel or inter-antenna-port group phase difference.

Example B6 may include the method of example B5 or some other example herein, wherein the value of Δᵢ could be pre-defined/configured. Or the value of Δᵢ could be up to UE capability and UE should report the supported value(s) to gNB.

Example B7 may include the method of example B1 and example B2 or some other example herein, wherein for uplink transmission, multiple panels/codewords could be used. Or for uplink transmission, antenna port group could be defined and each port group includes one or multiple antenna ports. The codebook could be generated according to Equation (3). W₁ is the matrix for panel selection/codeword selection/antenna port group selection.

Example B8 may include the method of example B7 or some other example herein, wherein the matrix of W₁ could be as shown by Equation (4). The value of bᵢ (1≤i≤M) could be bᵢ ∈ {0, 1}. Or the value of bᵢ could be bᵢ ∈ {0, 1, −1, j, −j}. The value of bᵢ in general can represent the inter-panel or inter-antenna port-group phase difference.

Example B9 may include the method of example B7 or some other examples herein, wherein the matrix of W₁ could be as shown by Equation (5).

Example B10 may include the method of example B1 and example B2 or some other example herein, wherein the codebook could be generated according to Equation (6).

Example B11 may include the method of example B1 and example B2 or some other example herein, wherein the codebook could be generated according to Equation (7). The matrix of W₁ could be as shown by Equation (8).

Example B12 may include the method of example B1 and example B2 or some other example herein, wherein the codebook could be generated according to Equation (9).

Example B13 may include the method of example B1 and example B2 or some other example herein, wherein the UE should report its coherence capability across panels/codewords/antenna port groups, e.g., whether relative phase can be maintained across panels/codewords/antenna port groups.

Example B14 includes a method of a next-generation NodeB (gNB) comprising:
determining configuration information for an uplink transmission by a user equipment (UE) using a non-uniform antenna array or multiple antenna panels, wherein the configuration information includes codebook information; and
encoding a message for transmission to the UE that includes the configuration information.

Example B15 includes the method of example B14 or some other example herein, wherein the uplink transmission is a physical uplink shared channel (PUSCH) transmission.

Example B16 includes the method of example B14 or some other example herein, wherein the codebook information is based on a matrix representing a phase difference between antenna ports and a precoder matrix.

Example B17 includes the method of example B16 or some other example herein, wherein the matrix representing the phase difference between antenna ports includes one or more entries representing an inter-panel or inter-antenna-port group phase difference.

Example B18 includes the method of example B14 or some other example herein, wherein the codebook information is associated with multiple antenna panels or multiple codewords.

Example B19 includes the method of example B14 or some other example herein, wherein the codebook information is associated with an antenna port group including multiple antenna ports.

Example B20 includes the method of example B14 or some other example herein, further comprising receiving, from the UE an indication of a coherence capability of the UE across one or more panels, codewords, or antenna port groups.

Example B20A includes the method of example B14 or some other example herein, further comprising receiving, from the UE, an indication of a full power capability across one or more panels, codewords, or antenna port groups.

Example B20B includes the method of example B14 or some other example herein, wherein the configuration information includes a plurality of TPMI fields, wherein each respective TPMI field is associated with a respective panel, codeword, or antenna port group.

Example B20C includes the method of example B14 or some other example herein, wherein the configuration information includes an indication of a block diagonal matrix for generating a codebook.

Example B21 includes a method of a user equipment (UE) comprising:
receiving, from a next-generation NodeB (gNB) configuration information for an uplink transmission by the UE using a non-uniform antenna array or multiple antenna panels, wherein the configuration information includes codebook information; and
encoding an uplink message for transmission to the gNB based on the configuration information.

Example B22 includes the method of example B21 or some other example herein, wherein the uplink transmission is a physical uplink shared channel (PUSCH) transmission.

Example B23 includes the method of example B21 or some other example herein, wherein the codebook information is based on a matrix representing a phase difference between antenna ports and a precoder matrix.

Example B24 includes the method of example B23 or some other example herein, wherein the matrix representing the phase difference between antenna ports includes one or more entries representing an inter-panel or inter-antenna-port group phase difference.

Example B25 includes the method of example B21 or some other example herein, wherein the codebook information is associated with multiple antenna panels or multiple codewords.

Example B26 includes the method of example B21 or some other example herein, wherein the codebook information is associated with an antenna port group including multiple antenna ports.

Example B27 includes the method of example B22 or some other example herein, further comprising encoding a reporting message for transmission to the gNB that includes an indication of a coherence capability of the UE across one or more panels, codewords, or antenna port groups.

Example B27A includes the method of example B14 or some other example herein, further comprising sending the gNB an indication of a full power capability across one or more panels, codewords, or antenna port groups.

Example B27B includes the method of example B14 or some other example herein, wherein the configuration information includes a plurality of TPMI fields, wherein each respective TPMI field is associated with a respective panel, codeword, or antenna port group.

Example B27C includes the method of example B14 or some other example herein, wherein the configuration information includes an indication of a block diagonal matrix for generating a codebook.

Example C1 may include the UE, wherein the UE can support full power Mode 2 operation.

Example C2 may include the method of example C1 or some other example herein, wherein the UE can perform antenna virtualization for full power Mode 2.

Example C3 may include the method of example C2 or some other example herein, wherein for 8Tx UE, the 8 Tx could be virtualized to 2 ports (the signal from 4Tx forms one port) or 4 ports (the signal from 2Tx forms one port).

Example C4 may include the method of example C2 or some other example herein, wherein for 8Tx UE, the 8Tx could be virtualized to 6 ports. For example, the signal from the first 4Tx forms 2 ports, and the rest 4Tx corresponds to 4 ports.

Example C5 may include the method of example C3 and example C4 or some other example herein, wherein for UE with 8Tx and full power Mode 2, how many ports could be formed by antenna virtualization could be up to UE capability.

Example C6 may include the method of example C2 or some other example herein, wherein for UE with multiple panels/codewords/antenna port groups, the antenna virtualization for full power Mode 2 should not be performed across different panels/codewords/antenna port groups. The total number of Tx of the UE is larger than 1, e.g., 2Tx/4Tx/6Tx/8Tx.

Example C7 may include the method of example C2 or some other example herein, wherein for UE with multiple panels/codewords/antenna port groups, the antenna virtualization for full power Mode 2 could be performed across different panels/codewords/antenna port groups. The total number of Tx of the UE is larger than 1, e.g., 2Tx/4Tx/6Tx/8Tx.

Example C8 may include the method of example C6 and example C7 or some other example herein, wherein whether antenna virtualization for full power Mode 2 could be performed across different panels/codewords/antenna port groups could be up to UE capability.

Example C9 may include a method to be performed by a user equipment (UE), one or more elements of a UE, and/or an electronic device that includes a UE, wherein the method comprises:
virtualizing 8 transmit antenna of the UE onto a number of ports, wherein the number of ports is less than 8; and
transmitting one or more uplink signals on the virtualized number of ports with full power Mode 2.

Example C10 may include the method of example C9, and/or some other example herein, wherein the number of ports is 4.

Example C11 may include the method of example C10, and/or some other example herein, wherein 2 antennas of the UE are virtualized onto a port.

Example C12 may include the method of example C9, and/or some other example herein, wherein the number of ports is 2.

Example C13 may include the method of example C12, and/or some other example herein, wherein 4 antennas are virtualized onto a port.

Example C14 may include the method of example C9, and/or some other example herein, wherein the number of ports is 6.

Example C15 may include the method of example C14, and/or some other example herein, wherein 2 antennas are virtualized onto a first port, 2 antennas are virtualized onto a second port, and 4 antennas are virtualized onto a respective port.

Example C16 may include the method of example C9, and/or some other example herein, wherein the number of ports is based on UE capability.

Example C17 may include the method of any of examples C9-C16, and/or some other example herein, wherein the antenna virtualization is not performed across different panels, codewords, or antenna port groups.

Example C18 may include the method of any of examples C9-C16, and/or some other example herein, wherein the antenna virtualization is performed across different panels, codewords, or antenna port groups.

Example C19 may include the method of any of examples C9-C16, and/or some other example herein, wherein identification of whether the antenna virtualization is performed across different panels, codewords, or antenna port groups is based on UE capability.

Example Z01 may include an apparatus comprising means to perform one or more elements of a method described in or related to any of examples A1-A22, B1-B27C, C1-C19, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A22, B1-B27C, C1-C19, or any other method or process described herein.

Example Z03 may include an apparatus comprising logic, modules, or circuitry to perform one or more elements of a method described in or related to any of examples A1-A22, B1-B27C, C1-C19, or any other method or process described herein.

Example Z04 may include a method, technique, or process as described in or related to any of examples A1-A22, B1-B27C, C1-C19, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A22, B1-B27C, C1-C19, or portions thereof.

Example Z06 may include a signal as described in or related to any of examples A1-A22, B1-B27C, C1-C19, or portions or parts thereof.

Example Z07 may include a datagram, packet, frame, segment, protocol data unit (PDU), or message as described in or related to any of examples A1-A22, B1-B27C, C1-C19, or portions or parts thereof, or otherwise described in the present disclosure.

Example Z08 may include a signal encoded with data as described in or related to any of examples A1-A22, B1-B27C, C1-C19, or portions or parts thereof, or otherwise described in the present disclosure.

Example Z09 may include a signal encoded with a datagram, packet, frame, segment, protocol data unit (PDU), or message as described in or related to any of examples A1-A22, B1-B27C, C1-C19, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A22, B1-B27C, C1-C19, or portions thereof.

Example Z11 may include a computer program comprising instructions, wherein execution of the program by a processing element is to cause the processing element to carry out the method, techniques, or process as described in or related to any of examples A1-A22, B1-B27C, C1-C19, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAFManagement Data Analytics Function
MDASManagement Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDMOrthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMATime Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-22. (canceled)

23. An apparatus for use in a user equipment (UE), wherein the apparatus comprises:
memory to store codebook information received from a next-generation NodeB (gNB), wherein the codebook information is related to an uplink transmission that uses a non-uniform antenna array of the UE; and
one or more processors configured to encode the uplink transmission for transmission to the gNB based on the codebook information.

24. The apparatus of claim 23, wherein the codebook information is based on a matrix representing a phase difference between antenna ports and a precoder matrix.

25. The apparatus of claim 24, wherein the matrix includes one or more entries representing an inter-panel or inter-antenna-port group phase difference.

26. The apparatus of claim 23, wherein the codebook information includes an indication of a block diagonal matrix for generating a codebook.

27. The apparatus of claim 23, wherein the codebook information is associated with one or more of: multiple antenna panels, multiple codewords, or one or more antenna port groups that include multiple antenna ports.

28. The apparatus of claim 23, wherein the instructions, when executed, further configure the UE to encode a message for transmission to the gNB that includes an indication of a coherence capability of the UE across one or more antenna panels, codewords, or antenna port groups.

29. The apparatus of claim 23, wherein the one or more processors are further configured to encode a message for transmission to the gNB that includes an indication of a full power capability across one or more panels, codewords, or antenna port groups.

30. The apparatus of claim 23, wherein the non-uniform antenna array includes a plurality of antenna elements with unequal spacing between adjacent antenna elements of the plurality of antenna elements.

31. One or more non-transitory computer-readable media (NTCRM) having instructions, stored thereon, that when executed by one or more processors of a next generation Node B (gNB) configure the gNB to:
encode, for transmission to a user equipment (UE), codebook information for an uplink transmission using a non-uniform antenna array of the UE; and
receive the uplink transmission from the UE based on the codebook information.

32. The one or more NTCRM of claim 31, wherein the codebook information is based on a matrix representing a phase difference between antenna ports and a precoder matrix.

33. The one or more NTCRM of claim 32, wherein the matrix includes one or more entries representing an inter-panel or inter-antenna-port group phase difference.

34. The one or more NTCRM of claim 31, wherein the codebook information includes an indication of a block diagonal matrix for generating a codebook.

35. The one or more NTCRM of claim 31, wherein the codebook information is associated with one or more of: multiple antenna panels, multiple codewords, or one or more antenna port groups that include multiple antenna ports.

36. The one or more NTCRM of claim 31, wherein the instructions, when executed, further configure the gNB to receive, from the UE, an indication of a coherence capability of the UE across one or more antenna panels, codewords, or antenna port groups, wherein the codebook information is based on the indication.

37. The one or more NTCRM of claim 31, wherein the instructions, when executed, further configure the gNB to receive an indication of a full power capability across one or more panels, codewords, or antenna port groups, wherein the codebook information is based on the indication.

38. The one or more NTCRM of claim 31, wherein the non-uniform antenna array includes a plurality of antenna elements with unequal spacing between adjacent antenna elements of the plurality of antenna elements.

39. One or more non-transitory computer-readable media (NTCRM) having instructions, stored thereon, that when executed by one or more processors of a user equipment (UE) configure the UE to:
virtualize 8 transmit antennas of the UE onto a number of virtual ports, wherein the number of ports is less than 8; and
transmit one or more uplink signals on the virtual ports with full power Mode 2.

40. The one or more NTCRM of claim 39, wherein the number of virtual ports is 4, and wherein pairs of the transmit antennas are virtualized onto the respective virtual ports.

41. The one or more NTCRM of claim 39, wherein the number of virtual ports is 2, and wherein 2 sets of 4 of the transmit antennas are virtualized onto the respective virtual ports.

42. The one or more NTCRM of claim 39, wherein the number of virtual ports is 6, wherein a first 2 of the transmit antennas are virtualized onto a first virtual port, a second 2 of the transmit antennas are virtualized onto a second virtual port, and 4 of the transmit antennas are virtualized onto a respective individual virtual ports.

43. The one or more NTCRM of claim 39, wherein the number of virtual ports is based on a UE capability.

44. The one or more NTCRM of claim 39, wherein the virtualization is performed across different antenna panels, codewords, or antenna port groups.
